(19) United States
(12) Patent Application Publication
(10) Pub. No.: US 2025/0239719 A1
(43) Pub. Date: Jul. 24, 2025

(54) LEAD WITH ELECTRICALLY INSULATING RESIN FILM

(71) Applicant: SUMITOMO ELECTRIC INDUSTRIES, LTD., Osaka (JP)

(72) Inventors: Koji KASUYA, Tochigi (JP); Shunichi SAWADA, Tochigi (JP); Kengo GOTO, Tochigi (JP); Akira TSUCHIKO, Osaka (JP)

(73) Assignee: SUMITOMO ELECTRIC INDUSTRIES, LTD., Osaka (JP)

(21) Appl. No.: 18/989,274

(22) Filed: Dec. 20, 2024

(30) Foreign Application Priority Data
Jan. 19, 2024 (JP) 2024-006588

(51) Int. Cl. H01M 50/342; H01M 50/105; H01M 50/178; H01M 50/186; H01M 50/193; H01M 50/197; H01M 50/375

(52) U.S. Cl. CPC H01M 50/342; H01M 50/105; H01M 50/178; H01M 50/186; H01M 50/193; H01M 50/197; H01M 50/375

(57) ABSTRACT

A lead with an electrically insulating resin film includes a conductor and an electrically insulating resin film. With the conductor being viewed from above, when an axis along two sides of the conductor facing each other is defined as an X-axis and an axis orthogonal to the X-axis is defined as a Y-axis, the electrically insulating resin film is disposed along the X-axis so as to cross and cover the conductor and overlap each other by extending beyond the conductor without covering two end portions of the conductor that are along the Y-axis. The electrically insulating resin film have a first layer in contact with the conductor and a second layer. The second layer includes a base resin and an added component. The base resin has a melting point of 110° C. to 130° C., and the added component has a softening point of 130° C. or less.

### CROSS REFERENCE TO RELATED APPLICATIONS

This application claims priority based on Japanese Patent Application No. 2024-006588 filed on Jan. 19, 2024, and the entire contents of the Japanese Patent Application are incorporated herein by reference.

### TECHNICAL FIELD

The present disclosure relates to a lead with an electrically insulating resin film.

### BACKGROUND

Patent literature (WO 2021/201213 A1) discloses a power storage device that includes at least a power storage device element including a positive electrode, a negative electrode, and an electrolyte, a power storage device packaging material for sealing the power storage device element, and a metal terminal electrically connected to each of the positive electrode and the negative electrode and protruding outside the power storage device packaging material and in which an adhesive film for a metal terminal is interposed between the metal terminal and the power storage device packaging material.

### SUMMARY

A lead with an electrically insulating resin film according to the present disclosure includes a conductor having a plate shape and having an upper surface and a lower surface each having a rectangular shape, and an electrically insulating resin film including a first electrically insulating resin film disposed at the upper surface of the conductor and a second electrically insulating resin film disposed at the lower surface of the conductor. With the conductor being viewed from above the upper surface vertically, when an axis along selected two sides of the conductor facing each other is defined as an X-axis and an axis orthogonal to the X-axis is defined as a Y-axis, the first electrically insulating resin film and the second electrically insulating resin film are disposed along the X-axis so as to cross and cover the conductor and to overlap each other by extending beyond the conductor without covering the two end portions of the conductor that are along the Y-axis. The first electrically insulating resin film and the second electrically insulating resin film each include a plurality of layers whose compositions are different from each other. The first electrically insulating resin film and the second electrically insulating resin film each have a first layer in contact with the conductor and a second layer different from the first layer. The second layer includes a base resin containing polypropylene as a main component and an added component including one or more components selected from a rubber component and an elastomer component. The base resin has a melting point of 110° C. to 130° C. The added component has a softening point of 130° C. or less. The second layer contains the added component in an amount of 10 mass % to 40 mass %.

### BRIEF DESCRIPTION OF THE DRAWINGS

FIG. 1 is a diagram illustrating a battery to which a lead with an electrically insulating resin film according to an embodiment of the present disclosure is applied.

FIG. 2 is a top view of a lead with an electrically insulating resin film according to an embodiment of the present disclosure.

FIG. 3A is a cross-sectional view taken along line A-A′ in FIG. 1.

FIG. 3B is a cross-sectional view taken along line A-A′ in FIG. 1 for another configuration example.

FIG. 4 is a diagram illustrating a method of measuring a temperature dependence of a seal strength.

FIG. 5 is a result of evaluating the temperature dependence of the seal strength in experimental examples.

FIG. 6 is a result of evaluating a heat deformation residual rate in the experimental examples.

### DETAILED DESCRIPTION

In the inside of various batteries sealed with an outer package, an electrolyte or the like generates heat due to reaction, and the temperature of the battery becomes higher than a usable temperature, which may cause gas generation. From the viewpoint of avoiding damage to the battery, the battery needs to be configured such that, when gas is generated in an area sealed with the outer package, the gas can be discharged to the outside of the area sealed with the outer package.

An object of the present disclosure is to provide a lead with an electrically insulating resin film that can discharge a gas generated in an are sealed with an outer package of a battery to an outside of the area sealed with the outer package when the lead is applied to the battery.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A lead with an electrically insulating resin film according to an embodiment of the present disclosure includes a conductor having a plate shape and having an upper surface and a lower surface each having a rectangular shape, and an electrically insulating resin film including a first electrically insulating resin film disposed at the upper surface of the conductor and a second electrically insulating resin film disposed at the lower surface of the conductor. With the conductor being viewed from above the upper surface vertically, when an axis along selected two sides of the conductor facing each other is defined as an X-axis and an axis orthogonal to the X-axis is defined as a Y-axis, the first electrically insulating resin film and the second electrically insulating resin film are disposed along the X-axis so as to cross and cover the conductor and to overlap each other by extending beyond the conductor without covering two end portions of the conductor that are along the Y-axis. The first electrically insulating resin film and the second electrically insulating resin film each include a plurality of layers whose compositions are different from each other. The first electrically insulating resin film and the second electrically insulating resin film each have a first layer in contact with the conductor and a second layer different from the first layer. The second layer includes a base resin containing polypropylene as a main component and an added component including one or more components selected from a rubber component and an elastomer component. The base resin has a melting point of 110° C. to 130° C. The added component has a softening point of 130° C. or less. The second layer contains the added component in an amount of 10 mass % to 40 mass %.

In the present specification, the term “lead with an electrically insulating resin film” may be simply referred to as “lead”.

By setting the melting point of the base resin contained in the second layer to 130° C. or less, the adhesive force between the second layer and another member in contact with the second layer can be reduced when the battery has a high temperature exceeding a usable temperature. Thus, even when gas is generated in an area sealed with an outer package when the battery has a high temperature exceeding the usable temperature, the gas can be discharged to the outside of the area sealed with the outer package.

In this specification, another member in contact with the second layer means a layer other than the second layer which is included in the electrically insulating resin film and in contact with the second layer, or the outer package when the second layer and the outer package are in contact with each other.

In addition, by setting the melting point of the base resin to 110° C. or more, it is possible to suppress a decrease in the adhesive force between the second layer and another member in contact with the second layer in a temperature range in which almost no gas is generated in the area sealed with the outer package, and to seal an electrode laminate and an electrolyte.

The second layer contains the added component. This can relax a stress applied to the electrically insulating resin film when a force is applied to the electrically insulating resin film so as to peel the lead from the outer package, so that an adhesive force between the second layer and another member in contact with the second layer can be increased. In addition, by setting the softening point of the added component to 130° C. or less, when the battery has a high temperature exceeding the usable temperature, the gas generated in the area sealed with the outer package can be discharged to the outside of the area sealed with the outer package.

By setting the amount of the added component in the second layer to 10 mass % or more, when a force is applied to the electrically insulating resin film so as to peel the lead from the outer package, the stress applied to the electrically insulating resin film is relaxed, and the adhesive force between the second layer and another member in contact with the second layer can be increased. Furthermore, by setting the amount of the added component in the second layer to 40 mass % or less, a decrease in a mechanical strength of the electrically insulating resin film can be suppressed.

(2) In the above (1), the base resin of the second layer may be cross-linked.

When the battery is manufactured, by disposing the outer package on the upper surface and the lower surface of the lead, and heating a region including a portion where the electrically insulating resin film of the lead and the outer package overlap each other while applying pressure, the lead can be thermally welded to the outer package. Since the base resin contained in the second layer is cross-linked, crushing of the electrically insulating resin film can be suppressed when the lead is thermally welded to the outer package. Thus, the shape of the electrically insulating resin film can be stabilized, and the adhesion of the lead to the outer package can be enhanced.

### Details of Embodiments of Present Disclosure

A specific example of a lead with an electrically insulating resin film according to one embodiment of the present disclosure (hereinafter, referred to as “the present embodiment”) will be described below with reference to the drawings. The present invention is not limited to these examples, and is defined by the scope of the claims, and is intended to include all modifications within the meaning and scope equivalent to the scope of the claims.

In this specification, the ordinal number “first”, “second”, or the like may be added to the name of a member for description, such as a first electrically insulating resin film or a second electrically insulating resin film. The ordinal numbers “first”, “second”, and the like are used only to distinguish the respective members and to prevent confusion in the description, and do not represent arrangement, priority, and the like. Thus, when there is no particular possibility of confusion between the members or when the members are collectively shown, the term like “electrically insulating resin film” can be simply used.

[Lead with Electrically Insulating Resin Film]

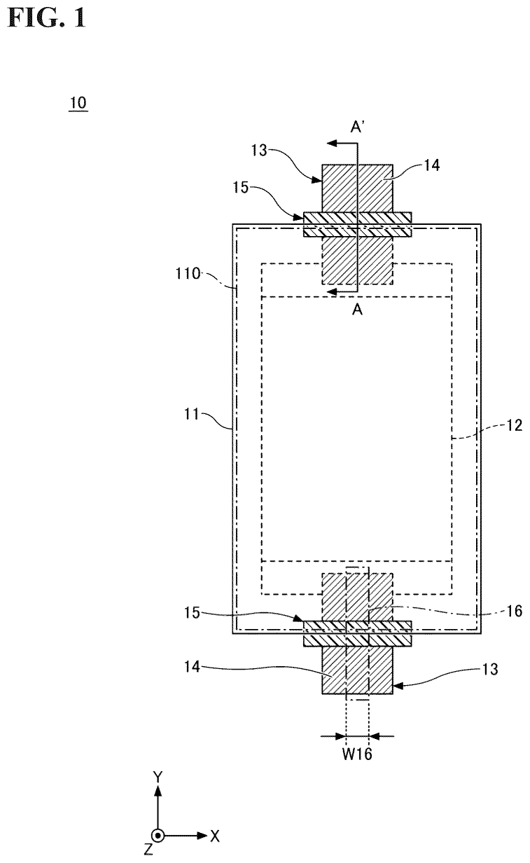

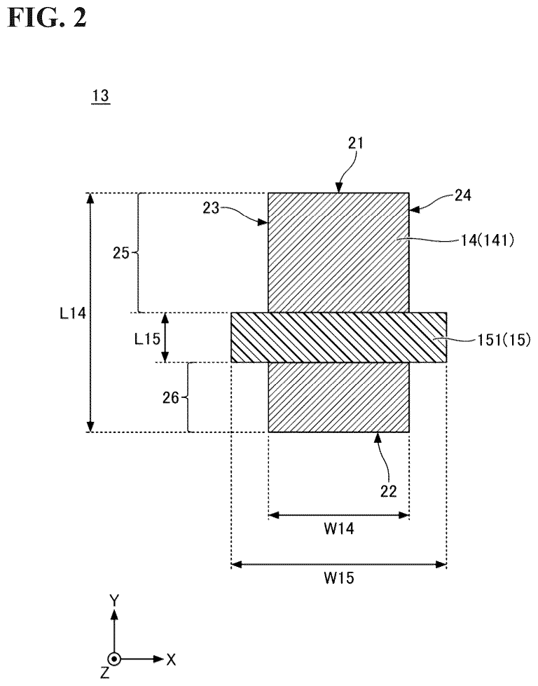

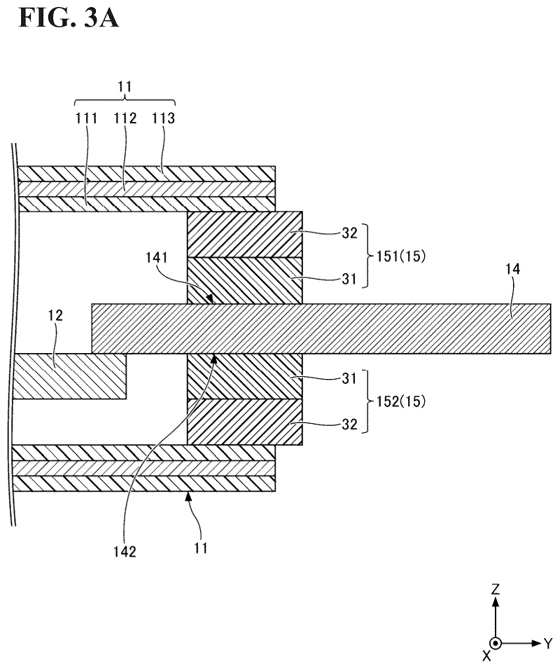

FIG. 1 is a diagram illustrating a configuration example in which the lead with the electrically insulating resin film of the present embodiment is applied to a battery. FIG. 2 is a top view of the lead with the electrically insulating resin film of the present embodiment, as viewed from above the upper surface of the conductor vertically. FIG. 3A is a cross-sectional view taken along line A-A′ in FIG. 1. FIG. 3B is a cross-sectional view taken along the line A-A′ in FIG. 1 for another configuration example. FIG. 3B shows a modification of the lead with the electrically insulating resin film of the present embodiment, the description will be made mainly with reference to FIG. 1, FIG. 2, and FIG. 3A, and FIG. 3B will be used as necessary.

A Z-axis shown in FIG. 1, FIG. 2, FIG. 3A, and FIG. 3B is an axis along a thickness of the conductor and the electrically insulating resin film included in the lead of the present embodiment.

A lead 13 of the present embodiment can be applied to a battery. Thus, after describing the battery to which lead 13 of the present embodiment can be applied, lead 13 of the present embodiment will be described in detail.

### (1) Battery

A configuration example of the battery to which lead 13 of the present embodiment is applied is shown in FIG. 1. As shown in FIG. 1, a battery 10 can include an outer package 11, an electrode laminate 12, and lead 13 of the present embodiment which is connected to electrode laminate 12. Electrode laminate 12 includes a positive electrode, a separator, and a negative electrode that are stacked and is impregnated with an electrolyte solution.

### (Outer Package)

Outer package 11 is a container that accommodates and seals electrode laminate 12 and the electrolyte solution. Outer package 11 can have at least one resin layer on a surface facing electrode laminate 12 so as to enable thermal welding.

As shown by a one-dot chain line in FIG. 1, a seal portion 110 is formed on a periphery of outer package 11, and electrode laminate 12 and the electrolyte solution are sealed with seal portion 110. The region surrounded by seal portion 110 is an area sealed with outer package 11.

### (2) Lead

A conductor 14 and an electrically insulating resin film 15, which are members included in lead 13 of the present embodiment, will be described.

### (2-1) Conductor

Conductor 14 is a member for connecting electrode laminate 12 disposed inside outer package 11 with a device disposed outside outer package 11. Conductor 14 can have a plate shape and has an upper surface 141 and a lower surface 142 (see FIG. 3A) each having a rectangular shape. As shown in FIG. 2, upper surface 141 of conductor 14 has two sides 21 and 22 facing each other and side 23 and side 24 intersecting side 21 and side 22. However, the rectangular shape does not mean a geometrically strict shape, and conductor 14 may have a shape with rounded corners.

In the following description, with conductor 14 being viewed from above upper surface 141 vertically, an axis along selected two sides 21 and 22 of conductor 14 facing each other is defined as an X-axis. An axis orthogonal to the X-axis is defined as a Y-axis.

The material of conductor 14 is not particularly limited, and various materials used for a conductor of a lead can be used, for example. Examples of the material of conductor 14 include metal materials such as aluminum, titanium, nickel, copper, aluminum alloys, titanium alloys, nickel alloys, and copper alloys, and materials obtained by plating these metal materials with nickel, gold, or the like.

### (2-2) Electrically Insulating Resin Film

As shown in FIG. 3A, electrically insulating resin film 15 includes a first electrically insulating resin film 151 disposed on upper surface 141 of conductor 14 and a second electrically insulating resin film 152 disposed on lower surface 142 of conductor 14. As shown in FIG. 2 and FIG. 3A, first electrically insulating resin film 151 and second electrically insulating resin film 152 are disposed on upper surface 141 and lower surface 142 so as not to cover but to expose two end portions of conductor 14 which are along the Y-axis, that is, two end portions including side 21 and side 22. Thus, on upper surface 141 and lower surface 142 of conductor 14, first electrically insulating resin film 151 and second electrically insulating resin film 152 are disposed along the X-axis so as to cross and cover conductor 14 at a middle portion of conductor 14 other than the two end portions that are along the Y-axis.

Upper surface 141 and lower surface 142 of conductor 14 refer to surfaces of conductor 14 facing outer package 11 of battery 10 when battery 10 is manufactured.

In conductor 14, the two end portions along the Y-axis mean a first end portion region 25 including side 21 and a second end portion region 26 including side 22 as shown in FIG. 2. The middle portion is a portion located between first end portion region 25 and second end portion region 26.

First end portion region 25 is a portion exposed to the outside of outer package 11, for example, when lead 13 is applied to the battery, and the size thereof can be selected so as to be connected to an external device. In addition, when lead 13 is applied to the battery, second end portion region 26 is a portion which is located, for example, inside outer package 11 and is connected to electrode laminate 12, and the size thereof can be selected so as to be connected to electrode laminate 12. First end portion region 25 and second end portion region 26 may be the same or different in size, such as an area.

Thus, a length L14 of conductor 14 along the Y-axis is longer than a length L15 of electrically insulating resin film 15. Furthermore, a length W15 of electrically insulating resin film 15 is longer than a length W14 of conductor 14 along the X-axis.

As shown in FIG. 2, first electrically insulating resin film 151 and second electrically insulating resin film 152 are disposed so as to overlap each other by extending beyond side 23 and side 24 of the conductor. In the portion extending beyond conductor 14, first electrically insulating resin film 151 and second electrically insulating resin film 152 are in direct contact with each other and are bonded to each other.

Lead 13 of the present embodiment is in close contact with seal portion 110 (see FIG. 1) at electrically insulating resin film 15.

The inventors of the present invention have studied lead 13 enabling gas in an area sealed with outer package 11 to be discharged to the outside when battery 10 has a high temperature exceeding a usable temperature and gas or the like is generated in the inside of battery 10 which is sealed with outer package 11 and provided with electrode laminate 12 and the like. The inventors have also found that, by forming a second layer 32 (see FIG. 3A) of electrically insulating resin film 15 included in lead 13 into a predetermined configuration, the adhesive force between second layer 32 and another member in contact with second layer 32 is reduced when gas is generated in the area sealed with outer package 11. Thus, the present inventors have found that when gas is generated in the area sealed with outer package 11, the gas can be discharged to the outside of the area sealed with outer package 11, and have completed the present invention.

### (2-2-1) Second Layer

Electrically insulating resin film 15 of lead 13 of the present embodiment, which is first electrically insulating resin film 151 and second electrically insulating resin film 152, can include a plurality of layers whose compositions are different from each other. First electrically insulating resin film 151 and second electrically insulating resin film 152 each have a first layer 31 in contact with conductor 14 and second layer 32 different from first layer 31. Second layer 32 can include a base resin containing polypropylene as a main component and an added component including one or more components selected from a rubber component and an elastomer component. Polypropylene as the main component means that polypropylene is the most abundant component contained in the base resin in terms of mass ratio.

### (Base Resin)

The base resin contained in second layer 32 may have a melting point of 110° C. to 130° C., or may be 120° C. to 130° C. By setting the melting point of the base resin contained in second layer 32 to 130° C. or less, the adhesive force between second layer 32 and another member in contact with second layer 32 can be reduced when the battery has a high temperature exceeding a usable temperature. Thus, even when gas is generated in the area sealed with outer package 11 in a case where the battery has a high temperature exceeding the usable temperature, the gas can be discharged to the outside of the area sealed with outer package 11.

In addition, by setting the melting point of the base resin to 110° C. or more, it is possible to suppress a decrease in the adhesive force between the second layer and another member in contact with the second layer in a temperature range in which almost no gas is generated in the area sealed with the outer package, and thus to seal the electrode laminate and the electrolyte.

The base resin contained in second layer 32 may be formed of only polypropylene, or may contain a resin that enables the melting point of the base resin to be within the above-described temperature range, in addition to polypropylene. As polypropylene, one or more types selected from a homopolymer, a block copolymer, and a random copolymer of polypropylene can be used.

The polypropylene homopolymer is a polymer formed of only propylene.

The polypropylene block copolymer is a copolymer having a polymer block formed of propylene and a polymer block formed of α-olefin other than propylene.

The polypropylene random copolymer is a random copolymer formed of propylene and α-olefin other than propylene. The α-olefin other than propylene is ethylene or the like, for example.

Examples of the resins other than polypropylene that can be contained in the base resin include one or more resins selected from polystyrene, polyvinyl alcohol, polyvinyl acetate, acrylic resin, ABS resin (acrylonitrile-butadiene-styrene copolymer synthetic resin), polyester resin, fluorine resin, and the like.

The base resin contained in second layer 32 may be cross-linked.

When battery 10 is manufactured, by disposing outer package 11 on the upper surface and the lower surface of lead 13 of the present embodiment, and heating a region including a portion where electrically insulating resin film 15 of lead 13 and outer package 11 overlap each other while applying pressure, lead 13 can be thermally welded to outer package 11. Since the base resin contained in second layer 32 is cross-linked, crushing of electrically insulating resin film 15 can be suppressed when lead 13 is thermally welded to outer package 11. Thus, the shape of electrically insulating resin film 15 can be stabilized, and the adhesion of lead 13 to outer package 11 can be enhanced.

### (Added Component)

Second layer 32 contains the added component. This can relax a stress applied to electrically insulating resin film 15 when a force is applied to electrically insulating resin film 15 so as to peel lead 13 from outer package 11, so that the adhesive force between second layer 32 and another member in contact with second layer 32 can be increased.

The added component contained in second layer 32 is not particularly limited, and a softening point of the added component can be set to 130° C. or less. In addition, by setting the softening point of the added component to 130° C. or less, when the battery has a high temperature exceeding a usable temperature, gas generated in the area sealed with outer package 11 can be discharged to the outside of the area sealed with outer package 11. The lower limit of the softening point of the added component is not particularly limited, and may be, for example, 35° C. or more, or may be 40° C. or more.

Second layer 32 may contain the added component in an amount of 10 mass % to 40 mass %. By setting the amount of the added component in second layer 32 to 10 mass % or more, when the force is applied to electrically insulating resin film 15 so as to peel lead 13 from outer package 11, the stress applied to electrically insulating resin film 15 is relaxed. This can increase the adhesive force between second layer 32 and another member in contact with second layer 32. Furthermore, by setting the amount of the added component in second layer 32 to 40 mass % or less, a decrease in a mechanical strength of electrically insulating resin film 15 can be suppressed.

The added component contained in second layer 32 is not particularly limited, and the type and the blending amount of the added component to be contained can be adjusted so that the softening point of the added component is 130° C. or less. Examples of the added components contained in second layer 32 include one or more types selected from ethylene-propylene rubber, butyl rubber, ethylene-propylene-diene rubber, styrene-butadiene rubber, urethane rubber, silicone rubber, natural rubber, acrylic rubber, and the like.

The added component contained in second layer 32 may be formed of only one type of added component or may be a mixture of two or more types of added components.

### (2-2-2) First Layer and Third Layer

Electrically insulating resin film 15 can include a layer other than second layer 32.

First electrically insulating resin film 151 and second electrically insulating resin film 152, which are electrically insulating resin films 15, can each include two or more layers as shown in FIG. 3A and FIG. 3B.

As shown in FIG. 3A, first electrically insulating resin film 151 and second electrically insulating resin film 152 each may be formed of only two layers, that is, first layer 31 and second layer 32.

Since first electrically insulating resin film 151 and second electrically insulating resin film 152 are each formed of only two layers, the number of steps for manufacturing electrically insulating resin film 15 and lead 13 can be reduced, and thus the productivity can be enhanced.

As shown in FIG. 3B, first electrically insulating resin film 151 and second electrically insulating resin film 152 each may be formed of only three layers, that is., first layer 31, a third layer 33, and second layer 32. In FIG. 3B, first layer 31, third layer 33, and second layer 32 are disposed in this order from a position closer to conductor 14, and second layer 32 is disposed so as to be in contact with outer package 11. However, the present invention is not limited to such a configuration. For example, first layer 31, second layer 32, and third layer 33 may be disposed in this order from the position closer to conductor 14, and third layer 33, which is a layer other than second layer 32, may be disposed so as to be in contact with outer package 11.

FIG. 3A and FIG. 3B are merely examples, and first electrically insulating resin film 151 and second electrically insulating resin film 152 can each have any number of layers, such as two or more layers.

When electrically insulating resin film 15 has a plurality of layers, each of the layers can have a different function. When electrically insulating resin film 15 includes three layers, electrically insulating resin film 15 can include the three layers each having a different function, for example, a layer that adheres to conductor 14, a layer that adheres to outer package 11, and a layer that is less likely to be crushed and maintains mechanical strength when lead 13 is welded to outer package 11.

When electrically insulating resin film 15 includes a plurality of layers, layers other than second layer 32 can also contain a resin. The layers of electrically insulating resin film 15 other than second layer 32 can contain, for example, a thermoplastic resin as the resin. As the thermoplastic resin, for example, one or more resins selected from a polyolefin resin, a polyester resin, a polystyrene resin, a polyvinyl chloride resin, and the like can be used. Examples of the polyolefin resins include polyethylene, polypropylene, and acid-modified polyolefin resins such as acid-modified polyethylene and acid-modified polypropylene. An example of the polyester resin includes a polyethylene terephthalate resin. An example of the acid-modified polyolefin includes maleic anhydride-modified polyolefin.

The material of each of the layers included in electrically insulating resin film 15 can be selected based on an intended function and the like. For example, acid-modified polypropylene is preferable for the layer to be adhered to conductor 14 in terms of adhesive force.

Since electrically insulating resin film 15 includes a plurality of layers, it is possible to adjust the mechanical strength of electrically insulating resin film 15, the adhesive force between electrically insulating resin film 15 and outer package 11, and the adhesive force between electrically insulating resin film 15 and conductor 14 which are characteristics after electrically insulating resin film 15 is thermally welded to outer package 11.

The number of included layers, the material and composition included in each of the layers, and the like may be different between first electrically insulating resin film 151 and second electrically insulating resin film 152, or may be the same.

### EXAMPLES

The present invention will be described below with reference to specific examples, but the present invention is not limited to these examples.

The leads fabricated in the respective experimental examples and the evaluation methods will be described below.

The experimental example 2 and experimental example 3 are working examples, and the experimental example 1 and experimental example 4 are comparative examples. In all of the experimental examples 1 to 4, first electrically insulating resin film 151 and second electrically insulating resin film 152 had the same configuration.

### Experimental Example 1

Lead 13 shown in FIG. 2 and FIG. 3A was fabricated.

First electrically insulating resin film 151 and second electrically insulating resin film 152 each had two layers, i.e., first layer 31 containing maleic anhydride-modified polypropylene and second layer 32 which were disposed in this order from a position closer to conductor 14.

The melting point of the base resin and the softening point of the added component contained in second layer 32 are as shown in Table 1. Table 1 also shows the amount of the added component in second layer 32.

The melting point of the base resin was measured with a differential scanning calorimeter (DSC). The softening point of the added component was measured with a nano thermal analysis system (TA).

The melting point of the base resin in second layer 32 was determined by measuring an endothermic reaction in the melting of the base resin. Specifically, the measurement was performed by heating second layer 32 at a heating rate of 10° C./min.

Furthermore, the distribution of softening points of the added component in second layer 32 was measured by utilizing the property that by heating a minute region in contact with a probe, softening a sample, and causing the probe to penetrate into the sample, a thermomechanical analysis was available. Second layer 32 was subjected to a fractionation NMR-GPC analysis in advance to analyze the components contained therein, and the softening point of the added component contained therein was determined by combining the analysis result with the distribution of softening points in second layer 32. The amount of the added component was determined by the fractionation NMR-GPC analysis.

Second layer 32 contains a polypropylene random copolymer as a base resin and an ethylene propylene rubber as an added component.

The base resin of second layer 32 is cross-linked.

### (Seal Strength Test)

Outer package 11 was thermally welded to lead 13 of this experimental example. As outer package 11, a laminate film in which a first resin layer 111 and a second resin layer 113 were polypropylene films and a metal layer 112 was an aluminum foil was used.

For lead 13 with outer package 11 thermally welded thereto, a rectangular region indicated by a one-dot chain line in FIG. 1 was cut with a press cutter to obtain a test piece 16. A width W16 of test piece 16 was 10 mm.

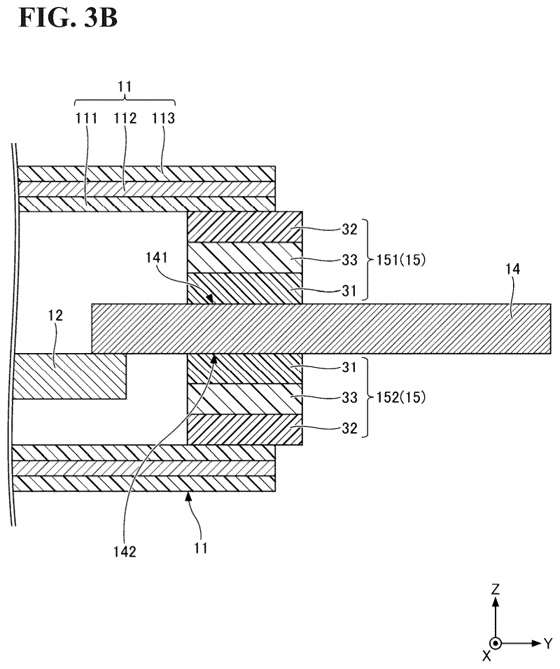

As shown in FIG. 4, an exposed portion of conductor 14 was clamped by a chuck 41 when outer package 11 was folded back. In this case, by bringing an abutment plate 42 into contact with a second outer package 11B disposed so as to cover lower surface 142 of conductor 14, test piece 16 was supported so as not to be tilted.

Next, after test piece 16 was heated to each test temperature, a first outer package 11A disposed so as to cover upper surface 141 of conductor 14 was pulled by a tensile tester as indicated by a block arrow B in FIG. 4. A tensile load at which first outer package 11A was peeled off from first electrically insulating resin film 151 was determined as a seal strength.

The test temperatures were 100° C., 110° C., 120° C., and 130° C. Test piece 16 was prepared for each of the test temperatures, and the tests were performed.

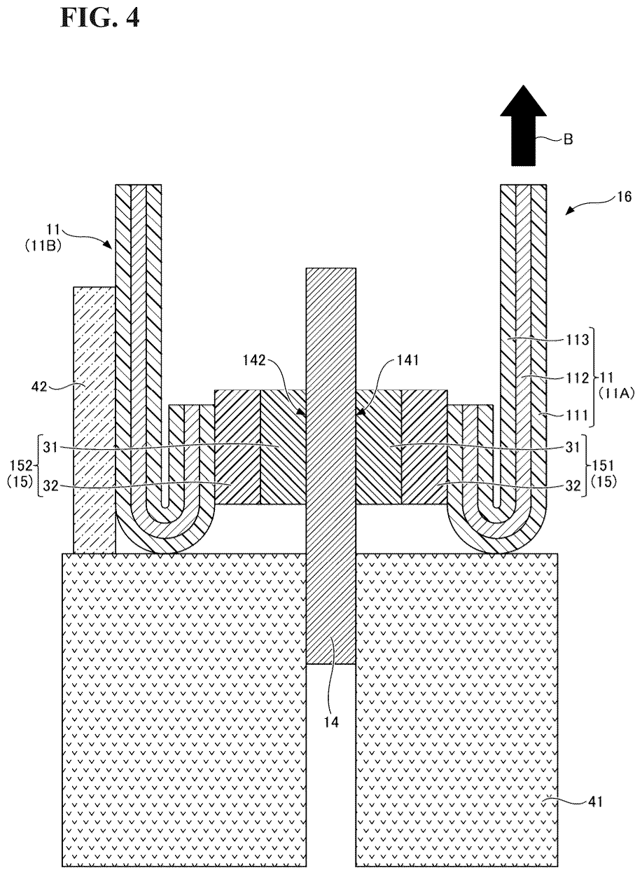

The evaluation results are shown in FIG. 5.

### (Heat Deformation Residual Rate)

Electrically insulating resin film 15 of the lead in this experimental example was subjected to a crushing experiment using a thermomechanical analyzer. Specifically, the surface of second layer 32 of electrically insulating resin film 15 was heated to raise the temperature while applying pressure with a probe, and a heat deformation residual rate was measured. The heating rate was 10° C./min, and the pressure applied to second layer 32 was 0.10 MPa.

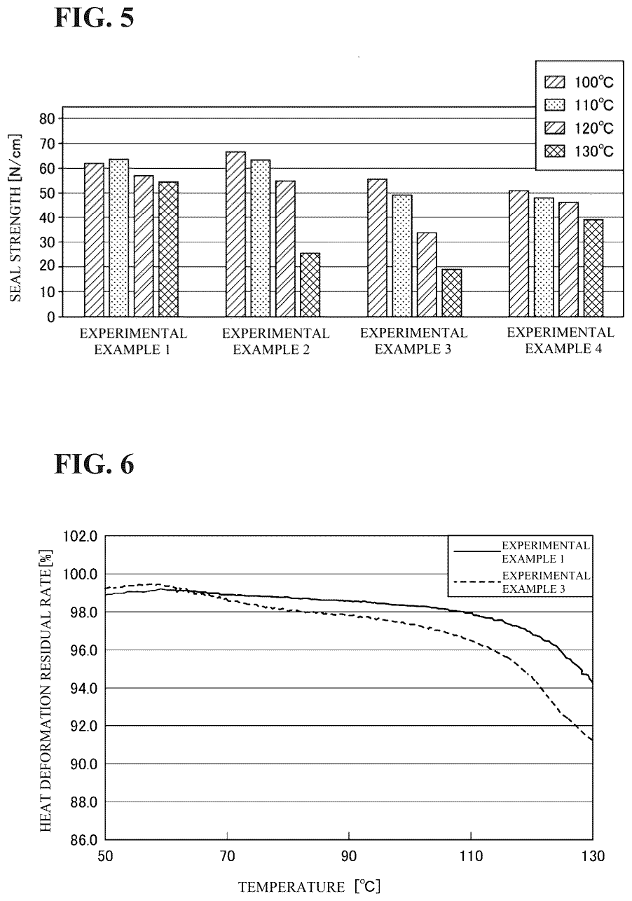

The evaluation results are shown in FIG. 6.

### Experimental Examples 2 to 4

The grade and the blending amount of each of raw materials were changed so that the melting point of the base resin contained in second layer 32, the softening point of the added component contained in second layer 32, and the amount of the added component in second layer 32 were the temperatures and the amounts shown in Table 1.

Except for the above points, leads were fabricated under the same conditions as in experimental example 1.

The seal strength tests were conducted using the fabricated leads in the same procedure as in experimental example 1. The evaluation results are shown in FIG. 5.

The heat deformation residual rate of experimental example 3 was measured in the same procedure as in Experimental Example 1. The evaluation results are shown in FIG. 6.

TABLE 1

| | Base resin | Added | Amount |
|---|---|---|---|
| | Melting | component | of added |
| | point | Softening point | component |
| | [° C.] | [° C.] | [mass %] |
| Experimental example 1 | 140 | 50 | 30 |
| Experimental example 2 | 128 | 50 | 30 |
| Experimental example 3 | 128 | 50 | 40 |
| Experimental example 4 | 140 | 120 | 50 |

According to FIG. 5, the seal strength, that is, the adhesion strength of the electrically insulating resin film to outer package 11 was rapidly decreased from 110° C. to 130° C. in the case of using the leads of experimental example 2 and experimental example 3, as compared with the case of using the leads of experimental example 1 and experimental example 4. Thus, it was confirmed that the leads of experimental example 2 and experimental example 3 were leads enabling gas to be discharge to the outside of the area sealed with outer package 11 when the gas was generated in the area sealed with outer package 11.

Furthermore, according to FIG. 6, in both of experimental example 1 and experimental example 3, since the resin of the second layer was cross-linked, it was confirmed that the heat deformation residual rate exceeded 80%, and the electrically insulating resin film did not crush even when thermal welding was performed.

What is claimed is:

1. A lead with an electrically insulating resin film, the lead comprising:
a conductor having a plate shape and having an upper surface and a lower surface each having a rectangular shape; and
an electrically insulating resin film including a first electrically insulating resin film disposed at the upper surface of the conductor and a second electrically insulating resin film disposed at the lower surface of the conductor,
wherein, with the conductor being viewed from above the upper surface vertically, when an axis along selected two sides of the conductor facing each other is defined as an X-axis and an axis orthogonal to the X-axis is defined as a Y-axis,
the first electrically insulating resin film and the second electrically insulating resin film are disposed along the X-axis so as to cross and cover the conductor and to overlap each other by extending beyond the conductor without covering two end portions of the conductor, the two end portions being along the Y-axis,
wherein the first electrically insulating resin film and the second electrically insulating resin film each include a plurality of layers whose compositions are different from each other,
wherein the first electrically insulating resin film and the second electrically insulating resin film each have a first layer in contact with the conductor and a second layer different from the first layer,
wherein the second layer includes a base resin and an added component, the base resin containing polypropylene as a main component, the added component including one or more components selected from a rubber component and an elastomer component;
wherein the base resin has a melting point of 110° C. to 130° C., and the added component has a softening point of 130° C. or less, and
wherein the second layer contains the added component in an amount of 10 mass % to 40 mass %.

2. The lead with the electrically insulating resin film according to claim 1,
wherein the base resin of the second layer is cross-linked.
